(19) United States
(12) Patent Application Publication
(10) Pub. No.: US 2007/0007063 A1
(43) Pub. Date: Jan. 11, 2007

(54) Electric bicycle

(76) Inventors: Ikuo Okamoto, Shizuoka-ken (JP); Toshiki Hirata, Shizuoka-ken (JP); Hu Ming Xiao, (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/484,327

(22) Filed: Jul. 10, 2006

(30) Foreign Application Priority Data
Jul. 11, 2005 (JP) 2005-201483

(51) Int. Cl. B62M 23/02

(52) U.S. Cl. 180/205

(57) ABSTRACT

An electric bicycle includes a light-weight crankshaft supporting unit. The crankshaft supporting unit has a U-shape and compactly supports both a battery and a pedal crankshaft. An electric motor is mounted remotely from the pedal crankshaft. A support shaft for a kick stand, a coupling shaft of a rear arm, and a mounting piece all extend between the sides of the crankshaft supporting member and add structural rigidity to the light-weight unit. The crankshaft supporting unit is compact and allows the battery to be placed lower so as to lower the bicycle's center of gravity.

### RELATED APPLICATIONS

The present application is based on and claims priority under 35 U.S.C. § 119(a)-(d) to Japanese Patent Application No. 2005-201483, filed on Jul. 11, 2005, the entire contents of which are hereby expressly incorporated by reference herein.

### BACKGROUND OF THE INVENTION

1. Field of the Invention

The present invention relates to an electric bicycle having a pedal portion and electric motor that both generate a driving force.

2. Description of the Related Art

Known electric bicycles have a power unit that combines an electric motor and pedal crank section. The electric motor generates a driving force while the pedal crank section allows a rider to input additional driving force. The power unit is preferably disposed low on the bicycle and near the center of gravity. A mounting bracket connected to the bicycle frame supports the pedal crank section. A cup-like case is fastened to a top surface of the mounting bracket and receives a bottom portion of a battery.

Because the battery is heavy, it is preferably also positioned near the center of gravity of the bicycle. For example, the battery may rest within the cup-like case attached to the mounting bracket and above the power unit. The battery thus is positioned adjacent to the center of gravity in a fore to aft direction of the body of the bicycle.

However, the battery is positioned relatively high because the mounting bracket is disposed between the battery and the power unit. Further, the inclusion of an electric motor within the power unit increases the size of the power unit. Therefore, the center of gravity of the electric bicycle is also high. In addition, the mounting bracket adds an additional part to the electric bicycle.

### SUMMARY OF THE INVENTION

In view of the foregoing, a need exists for an electric bicycle having a lower center of gravity while compactly arranging the components and parts of the electric bicycle without appreciably increasing the number of parts of the electric bicycle.

An aspect of the invention is directed to an electric bicycle having a pedal crankshaft, a crankshaft supporting unit for supporting the pedal crankshaft, and an electric motor. The electric bicycle further comprises a battery for driving the electric motor and a bottom receiving section disposed above the crankshaft supporting unit for holding the battery.

Another aspect of the invention is directed to an electric bicycle comprising a crankshaft supporting unit. The crankshaft supporting unit comprises a pair of side sections, each side section having an upper surface. The upper surfaces are configured to support a support. The crankshaft supporting member further comprises a front section connected to the pair of side sections and a pedal crankshaft that extends between the pair of side sections.

Another aspect of the invention is directed to an electric bicycle having a pedal crankshaft and an electric motor disposed remotely from the pedal crankshaft. The electric bicycle further comprises a battery for driving the electric motor and a crankshaft unit that supports the pedal crankshaft and defines a support surface that faces in a generally upward direction. The electric bicycle further comprises a mounting bracket disposed on the support surface so as to support the battery.

The systems and methods of the invention have several features, no single one of which is solely responsible for its desirable attributes. Without limiting the scope of the invention as expressed by the claims, its more prominent features have been discussed briefly above. After considering this discussion, and particularly after reading the section entitled “Detailed Description of the Preferred Embodiments,” one will understand how the features of the system and methods provide several advantages over conventional electric bicycles.

### BRIEF DESCRIPTION OF THE DRAWINGS

These and other features, aspects and advantages of the present invention will now be described in connection with preferred embodiments of the invention, in reference to the accompanying drawings. The illustrated embodiments, however, are merely examples and are not intended to limit the invention. The following are brief descriptions of the drawings.

FIG. 1 is a side view showing an electric bicycle configured in accordance with a preferred embodiment of the present invention.

FIG. 2 is a partial front plan view of an upper portion of the electric bicycle of FIG. 1 showing a handlebar assembly thereof.

FIG. 3 is a side view of a frame portion of the electric bicycle of FIG. 1.

FIG. 4 is a top plan view of a crankshaft supporting unit of the electric bicycle of FIG. 1.

FIG. 5 is a front plan view of the crankshaft supporting unit of FIG. 4.

FIG. 6 is a side view of the crankshaft supporting unit of FIG. 4.

FIG. 7 is a rear view of the crankshaft supporting unit of FIG. 4.

FIG. 8 is a perspective view of a portion of the electric bicycle of FIG. 1 showing the major components supported by the crankshaft supporting unit.

FIG. 9 is a perspective bottom view of the portion of the electric bicycle shown in FIG. 8.

FIG. 10 is a side view of a portion of the electric bicycle shown in FIG. 1 with the battery in the process of being inserted into a battery container.

FIG. 11 is a side view of a portion of the electric bicycle shown in FIG. 1 with the battery inserted into the battery container.

FIG. 12 is a bottom view of the portion of the electric bicycle shown in FIG. 9.

FIG. 13 is a perspective side view of a lower portion of the electric bicycle shown in FIG. 11 with a kick stand in solid lines when in a down position and in phantom lines when in an up position.

### DETAILED DESCRIPTION OF THE PREFERRED EMBODIMENTS

The following detailed description is now directed to certain specific embodiments of the invention. However, the invention can be embodied in a multitude of different systems and methods. In this description, reference is made to the drawings wherein like parts are designated with like numerals throughout the description and the drawings.

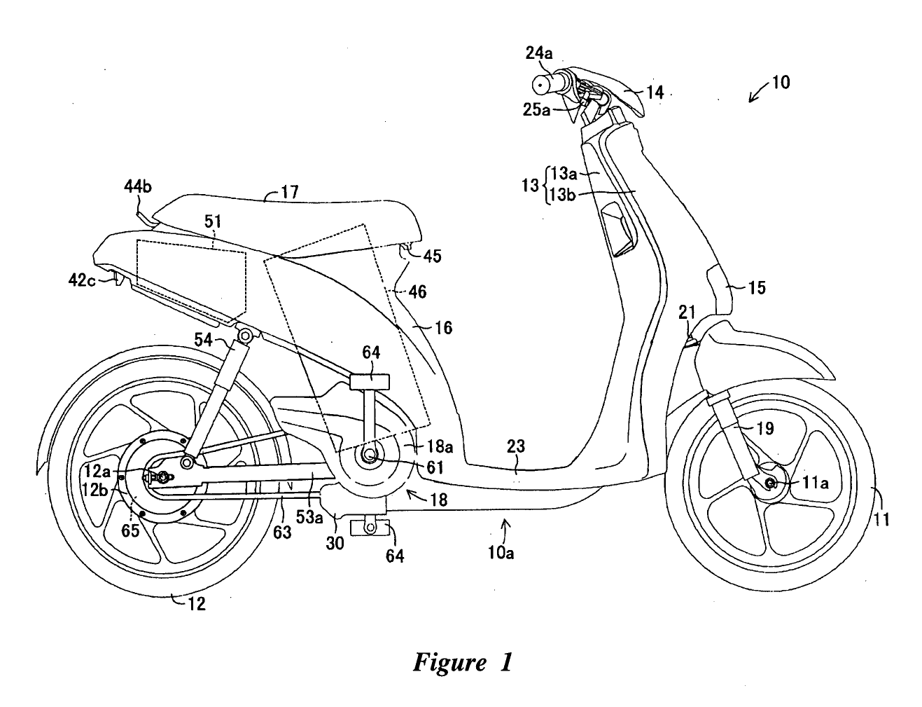

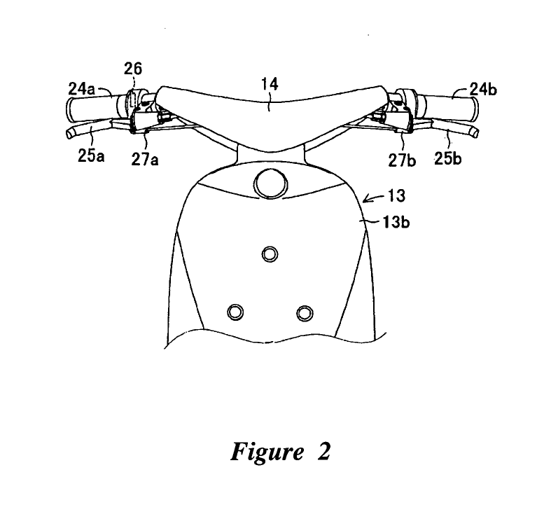

FIG. 1 is a side view showing an electric bicycle 10 configured in accordance with a preferred embodiment of the present invention. FIG. 2 is a partial front plan view of an upper portion of the electric bicycle 10 of FIG. 1 showing a handlebar assembly thereof. The electric bicycle 10 may include a body 10a and wheels mounted to the body 10a. The wheels may include a front wheel 11 and a rear wheel 12.

The body 10a may include a handlebar 14, a front cover member 13, a connection cover member 23, and a rear cover member 16. As illustrated in FIG. 1, a light 15 is located near the center of the front cover member 13. The rear cover member 16 has a seat 17 formed on an upper surface. A lower portion of the body 10a includes a pedal crank section 18. A rider may input driving force to the pedal crank section 18.

The body 10a may further include a front fork 19 which supports the front wheel 11 and a head pipe 21. A center shaft 11a of the front wheel 11 is rotatably attached to the lower end portions of the front fork 19 to allow the front wheel 11 to rotate about the center shaft 11a.

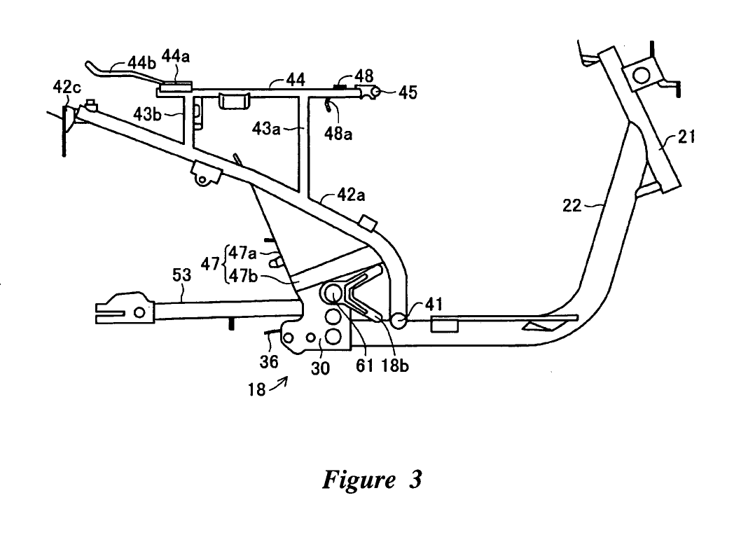

FIG. 3 is a side view of a frame portion of the electric bicycle of FIG. 1. As most clearly shown in FIG. 3, the head pipe 21 connects to a down tube 22 of the body 10a. As illustrated in FIGS. 1 and 3, the down tube 22 is located inside the connection cover member 23.

Returning to FIG. 2, a steering shaft (not shown) connects to the front fork 19 and is mounted inside the head pipe 21. An upper portion of the steering shaft extends from an upper end portion of the head pipe 21 to connect with the handlebar 14. Turning the handlebar 14 axially rotates the steering shaft so as to change the direction of the front wheel 11.

As most clearly shown in FIG. 2, left and right grips 24a, 24b are disposed at the ends of the handlebar 14. The grip 24a is axially rotatable and controls the rotational speed of an electric motor 65. A potentiometer 26 detects the amount of rotation of the grip 24a. Brake levers 25a, 25b are disposed near the grips 24a and 24b, respectively. The brake levers 25a and 25b are spaced from the grips 24a, 24b, and when pulled towards the grips 24a, 24b serve to suppress the rotation of the front wheel 11 or rear wheel 12, respectively. Brake switches 27a and 27b connected to the brake levers 25a and 25b detect when the brake levers 25a and 25b are pulled towards the grips 24a, 24b.

As most clearly shown in FIG. 1, the front cover member 13 may have a rear surface cover portion 13a and a front surface cover portion 13b. The rear surface cover portion 13a and the front surface cover portion 13b may be fixed in place with a plurality of screws and form a space therebetween. The space may house the head pipe 21, the down tube 22, the steering shaft, a controller for electrically controlling a drive system, and a power supply switch (not shown).

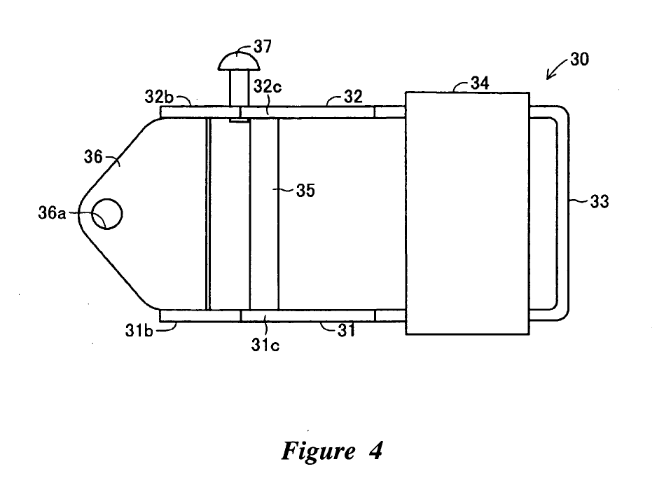

As most clearly shown in FIGS. 3 and 4, the down tube 22 extends in a rearward and diagonally downward direction from the head pipe 21 and then curves so as to extend horizontally in a rearward direction. A pair of rear frames 42a, 42b extends diagonally upward within the rear cover member 16. The rear frames 42a, 42b connect to the rear side of the down tube 22 via a horizontal support bar 41. A plate-like connecting member 42c connects the rear end portions of the rear frames 42a and 42b together.

The down tube 22 is a single member disposed at the center of the body 10a. The horizontal support bar 41 or cross member extends generally in a horizontal direction and is fixed to a rear section of the down tube 22. Respective end portions of the pair of rear frames 42a, 42b are coupled with both end portions of the cross member 41. Because the right and left rear frames 42a, 42b couple with the single down tube 22, the structure of the bicycle 10 is simpler and lighter.

Pipe-like suspension members 43a, 43b having different lengths are connected to the respective upper surfaces of the rear frames 42a and 42b while maintaining a predetermined spacing therebetween. The heights of the upper end portions of the suspension members 43a and 43b are set to be substantially the same. A seat rail 44 is connected to the upper end portions. The seat rail 44 may have a U-shape and connects to the upper end portion of each of the suspension members 43a and 43b so that the curved portion of the U-shaped seat rail 44 is located on the front side of the electric bicycle 10.

An auxiliary seat rail 44b connects via connecting members 44a to both rear end portions of the seat rail 44. The seat rail 44 and the auxiliary seat rail 44b define a frame portion. In the illustrated embodiment, the frame portion has a longitudinally elongated, substantially elliptical shape.

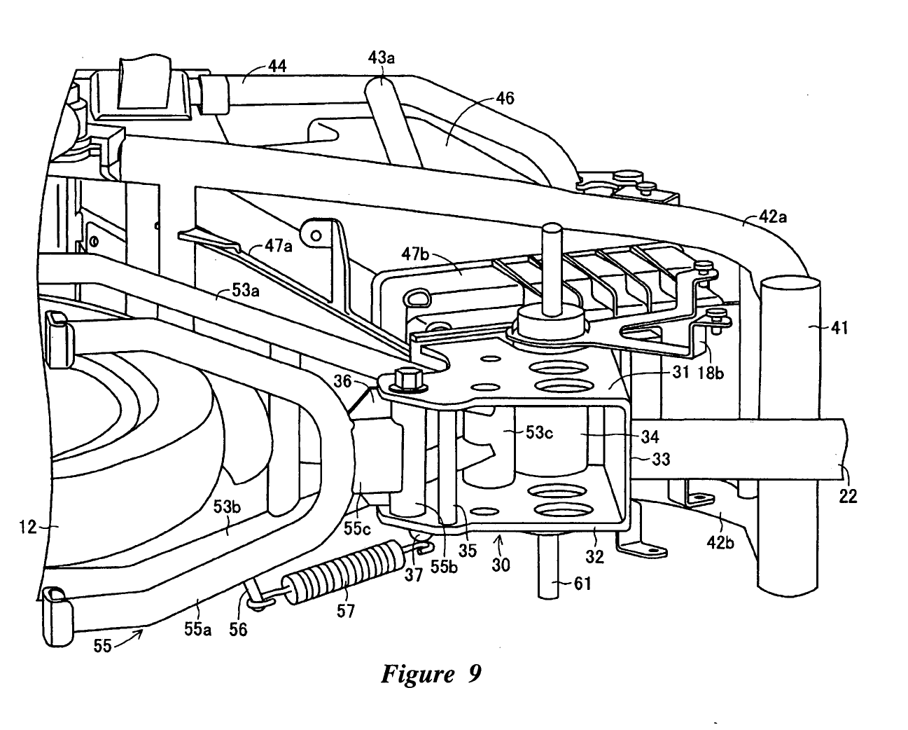

As most clearly shown in FIG. 3, the electric bicycle 10 further includes a rear arm 53 connected to a rear portion of the down tube 22 via a crankshaft supporting unit 30. The crankshaft supporting unit is described in detail with reference to FIGS. 4 through 7. The rear arm 53 includes a pair of parallel arm members 53a, 53b connected together at their front end portions. As most clearly shown in FIGS. 1 and 9, the arm members 53a, 53b support a center shaft 12a about which the rear wheel 12 rotates. A rear cushion or shock absorber 54 connects between an upper portion of each arm member 53a, 53b and a corresponding rear frame 42a, 42b. The rear arm 53 can swing up and down due to the expansion and contraction of the rear cushion 54.

The electric bicycle 10 further includes a transmission case 12b located at a central region of the rear wheel 12. The transmission case 12b may house the electric motor 65 and a reduction gear. The electric motor 65 generates driving force in the rear wheel 12. A drum brake (not shown) may be mounted to the left side of the transmission case 12b. The front wheel 11 also has a brake (not shown). The front and rear brakes are activated by operation of their respective brake levers 25a, 25b. As most clearly shown in FIG. 9, a rotary stand 55 may keep the electric bicycle 10 upright when the bicycle is stationary.

A controller controls the electric motor 65 based on how much the rider rotates the grip 24a. When the brake levers 25a and 25b are operated, the controller stops the electric motor 65.

Returning to FIG. 1, the electric bicycle 10 further includes a chain 63 suspended between gears of the pedal crank section 18 and the rear wheel 12. As the rider's feet rotate pedals 64, a human generated driving force is transmitted from the pedal crank section 18 to the rear wheel 12 via the chain 63.

As most clearly shown in FIG. 3, the body 10a may further include a battery container 47 for supporting a battery 46 mounted within the body 10a. The battery container 47 may be L-shaped and have an inclining guide section 47a and a bottom receiving section 47b. The battery container 47 may be mounted between the rear frames 42a, 42b and angled so that the bottom receiving section 47b is located near the front side of the rear frames 42a, 42b.

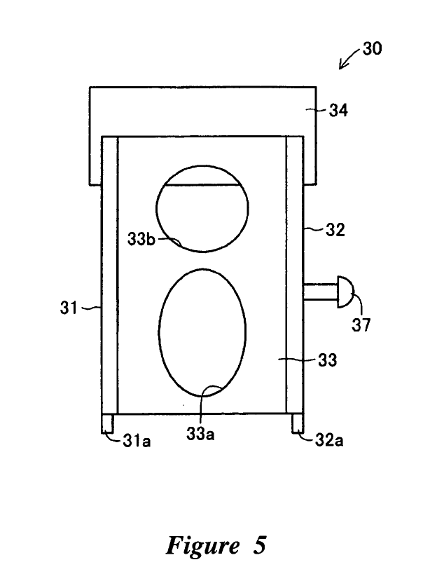

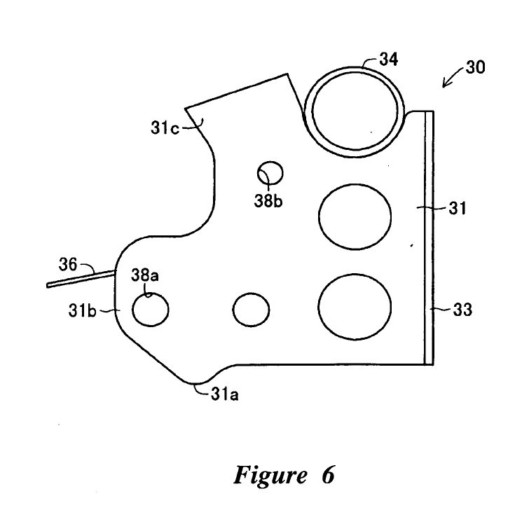

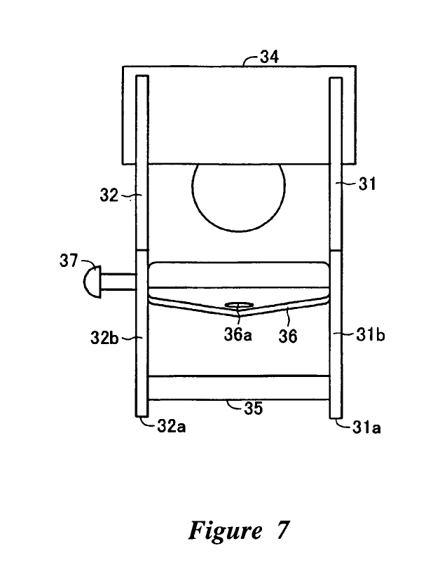

FIG. 4 is a top plan view of the crankshaft supporting unit 30 of the electric bicycle 10 of FIG. 1. FIG. 5 is a front plan view of the crankshaft supporting unit 30 of FIG. 4. FIG. 6 is a side view of the crankshaft supporting unit of FIG. 4. FIG. 7 is a rear view of the crankshaft supporting unit of FIG. 4. The crankshaft supporting unit 30 is attached to a rear end portion of the down tube 22 and includes a right and left pair of side sections 31, 32 and a front section 33 connecting the side sections 31, 32 to each other.

The side sections 31, 32 may have the same shape and be disposed opposite to each other and on opposite sides of the longitudinal axis. As most clearly shown in FIG. 6, the front and bottom sides of the side section 31, 32 are generally straight. The bottom sides of the side section 31, 32 may each have a small projection 31a, 32a that extends in a downward direction. The rear sides of the side sections 31, 32 each have a projection 31b, 32b that extends in a rearward direction. The rear sides of the side section 31, 32 may each have a concave shape above the projections 31b, 32b.

A semi circular recessed portion that receives the cylindrical holder 34 may be located on the top surface of each side section 31, 32. The rear-most ends of the top surfaces may include support pieces 31c, 32c. The support pieces 31c, 32c extend obliquely in an upward and rearward direction from the respective side section 31, 32. The support pieces 31c, 32c support the bottom receiving section 47b.

The side sections 31, 32 may have openings 38a, 38b in the projections 31b, 32b. Each side section 31, 32 also may have three openings other than the openings 38a, 38b.

As shown most clearly in FIG. 5, the front section 33 has an oblong rectangular shape. A lower portion of the front section 33 has a fixing part 33a to which the rear end portion of the down tube 22 is fixed. An upper portion of the front section 33 has a circular opening 33b.

As most clearly illustrated in FIG. 4, a mounting piece 36 extends between upper portions of the respective projections 31b, 32b. The mounting piece 36 may extend obliquely in a downward and rearward direction. The mounting piece 36 may taper in the rearward direction. A rear-most end of the mounting piece 36 has an opening 36a.

As shown most clearly in FIG. 7, a reinforcing bar 35 extends between the side sections 31, 32 in a lower region of the crankshaft supporting unit 30 and adjacent to the projections 31a and 32a. A spring hooking pin 37 extends from an outer surface of a rear potion of the side section 32.

The crankshaft supporting unit 30 further includes a cylindrical holder 34 transversely extending over a portion thereof and adjacent to the front section 33. The cylindrical holder 34 supports a pedal crankshaft 61, which will be described below.

The crankshaft supporting unit 30 directly supports the pedal crankshaft 61 and the bottom receiving section 47b. The battery 46 thus can be positioned as close to the pedal crankshaft 61 as possible. That is, the battery 46 can be placed at a low position above the pedal crankshaft 61 so as to lower the center of gravity of the electric bicycle 10.

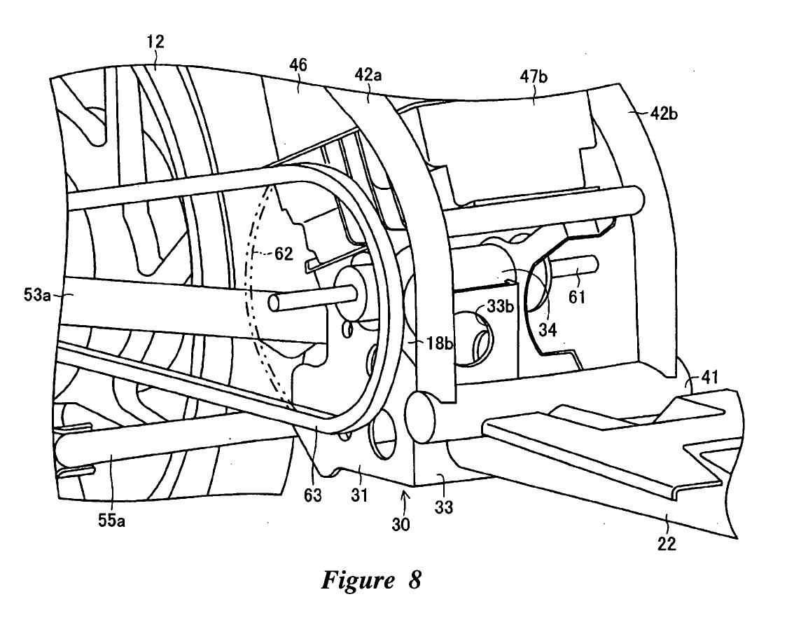

FIG. 8 is a perspective view of a portion of the electric bicycle 10 of FIG. 1 showing the major components supported by the crankshaft, supporting unit 30. FIG. 9 is a perspective bottom view of the portion of the electric bicycle 10 shown in FIG. 8.

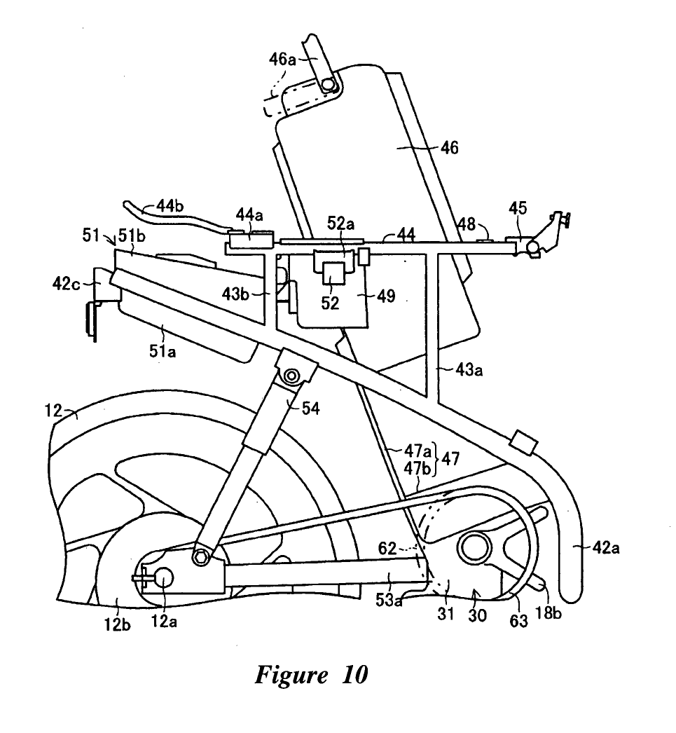

FIG. 10 is a side view of a portion of the electric bicycle shown in FIG. 1 with the battery in the process of being inserted into a battery container. The battery 46 can slide obliquely downward from a top end of the inclining guide section 47a and along a surface of the guide section 47a into the battery container 47. The inclining guide section 47a is inclined relative to horizontal so that the lower portion of the inclining guide section 47a is located forward of the top portion of the inclining guide section 47a. The bottom receiving section 47b may have a box shape with an upper opening for receiving the battery 46.

A T-shaped support member 48 is bridged over the front end-side portion of the seat rail 44. A regulating member 48a is mounted to the lower end portion of the support member 48. The regulating member 48a contacts an upper portion of the front surface of the battery 46 and inhibits longitudinal rocking of the battery 46 together with the inclining guide section 47a.

Support plates 49 are mounted to the seat rail 44 and extend in a downward direction on either side of the battery container 47. The inclining guide section 47a, the rear frames 42a and 42b, the regulating member 48a, and the respective support plates 49 form the battery container 47. The rear frames 42a, 42b are disposed on lateral sides of the battery 46. The rear frames 42a, 42b thus do not protrude beyond the body 10a of the electric bicycle 10 in a transverse direction. Accordingly, the electric bicycle 10 may be narrower in the transverse direction.

A connecting member or hinge 45 allows the seat 17 to rotate or pivot relative to the seat rail 44. A portion of the hinge 45 is fixed to the seat 17. The seat 17 rotates about an axis of the hinge coupling 45.

A lock mechanism (not shown) may be attached to an upper center portion of the inclining guide section 47a and to a portion of a lower surface of the seat 17 opposing to the upper center portion of the inclining guide section 47a. The lock mechanism is in a locked state when the seat 17 is pressed onto the seat rail 44. The rider may unlock the lock mechanism with a key.

A charging connector 52 is mounted to a bracket 52a. The bracket 52a is attached to the seat rail 44 and the support plate 49. The connector 52 is disposed so that an end of the connector 52 may be connected to the battery 46 in the battery storage compartment. Through an opening in the support plate 49, another end of the connector 52 may be connected to a charging terminal (not shown) to charge the battery 46.

When the seat 17 is lifted up to open the battery storage compartment, the charging terminal of the connector 52 is exposed. When the seat 17 is lowered to close the battery storage compartment, the charging terminal is hidden under the seat 17. Accordingly, the connector 52 may be disposed in a compact manner within the rear cover member 16 and the seat 17. The battery 46 may be charged with the seat 17 in the closed position with the connector 52 connected to the power source by a connection cord.

The electric bicycle 10 further comprises a storage container 51 fixed to the rear end portions of the rear frames 42a, 42b. The storage container 51 defines an article storage compartment for, for example, a helmet. To maximize the volume of the article storage compartment, the sides of the storage container 51 may closely follow the contours of the rear frames 42a, 42b. For example, a lower portion 51a of the storage container 51 which is located below the upper surface of the rear frames 42a, 42b, may be narrower than an upper portion 51b of the storage container 51. That is, the lower portion 51a may have a box shape and extend down between the rear frames 42a, 42b. The upper portion 51b of the storage container 51 located above the upper surface of the rear frames 42a, 42b may have a greater width than the lower portion 51a. Thus, the lower portion 51a is smaller in width than the upper portion 51b.

The upper portion 51b sits on the top surfaces of the rear frames 42a, 42b and extends in an upward direction. Accordingly, the upper portion 51b is larger in width than the portion between the rear frames 42a and 42b. The lengths of the upper and lower portions of the storage container 51 illustrated in FIG. 10 are approximately the same. The illustrated embodiment increases the volume of the storage container 51 as a whole while the rear frames 42a, 42b protect the lower portion 51a of the storage container 51.

Of course the invention is not so limited. The storage container 51 could have any number of different dimensions measured in the lateral, longitudinal, or transverse directions depending on the dimensions of the electric bicycle 10 and the desired size of the storage container 51. Moreover, the storage container could have three or more portions, each having a different shape or dimension than another portion.

The inclining guide section 47a separates the storage container 51 from the battery container 47. Preferably, the perimeters of the battery container 47 and container 51, the rear frames 42a and 42b, and the seat rail 44 are covered by the rear cover member 16. The openings into the storage and battery compartments are accessible when the seat 17 is in the open position.

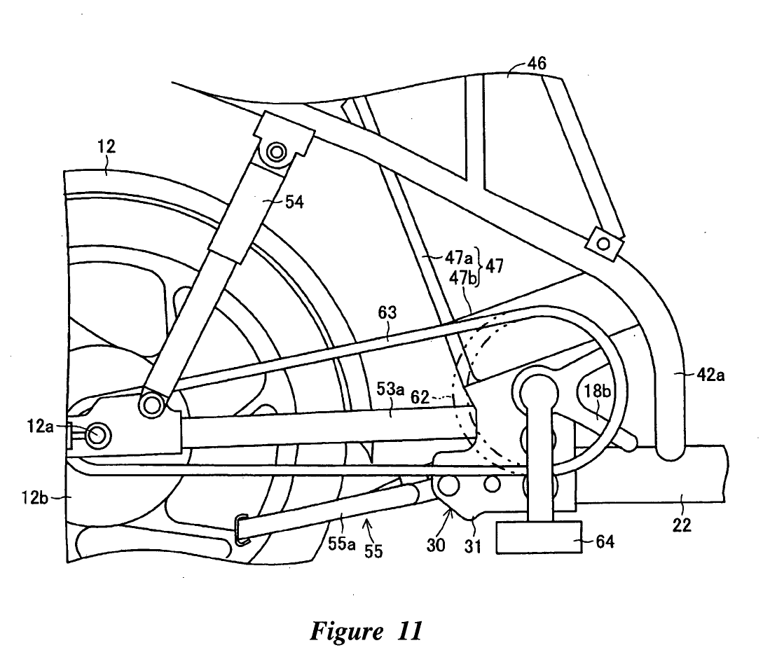

FIG. 11 is a side view of a portion of the electric bicycle 10 shown in FIG. 1 with the battery 46 inserted into the battery container 47. As most clearly shown in FIG. 10, the battery 46 preferably has a handle 46a on an upper surface. The handle 46a may be rotated between a low profile position where the handle 46a is folded against the upper rear edge of the battery 46 and a position where the handle 46a is spaced from the battery 46 so as to be grasped. When spaced from the battery 46, the rider grasps the handle 46a to move the battery 46. When the battery 46 is installed within the battery storage compartment, the lower portion of the battery 46 is inserted into the bottom receiving section 47b, thereby inhibiting longitudinal and lateral movements of the battery 46. The inclining guide section 47a and the regulating member 48a inhibit longitudinal movement of the upper portion of the battery 46. The support plates 49 inhibit lateral movement of the battery 46.

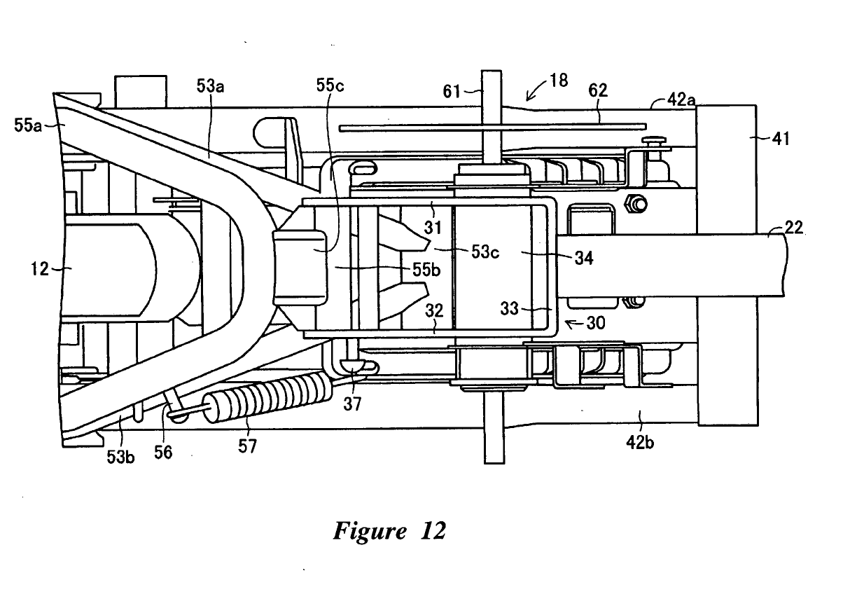

FIG. 12 is a bottom view of the portion of the electric bicycle 10 shown in FIG. 9. The rear arm 53 is coupled with the crankshaft supporting unit 30 at the openings 38b. The rear arm 53 has a pair of arm sections 53a, 53b. A coupling shaft 53c couples respective base portions (front end portions) of the arm sections 53a, 53b together. The forward or base portions of the arm sections 53a, 53b extend normal to the axis of the coupling shaft 53c. The rear portions of the arm sections 53a, 53b extend away from each other and then curve so as to follow parallel paths in the rearward direction.

The coupling shaft 53c extends between the side sections 31, 32 of the crankshaft supporting unit 30 through the openings 38b. The side sections 31, 32 support the coupling shaft 53c so that a rear end portion of the rear arm 53 is swingable. By journaling the coupling shaft 53c, the rigidity of the crankshaft supporting unit 30 is improved for supporting the battery 46. The side sections 31, 32 are journaled to the coupling shaft 53c which improves the rigidity of the crankshaft supporting unit 30 while being light weight.

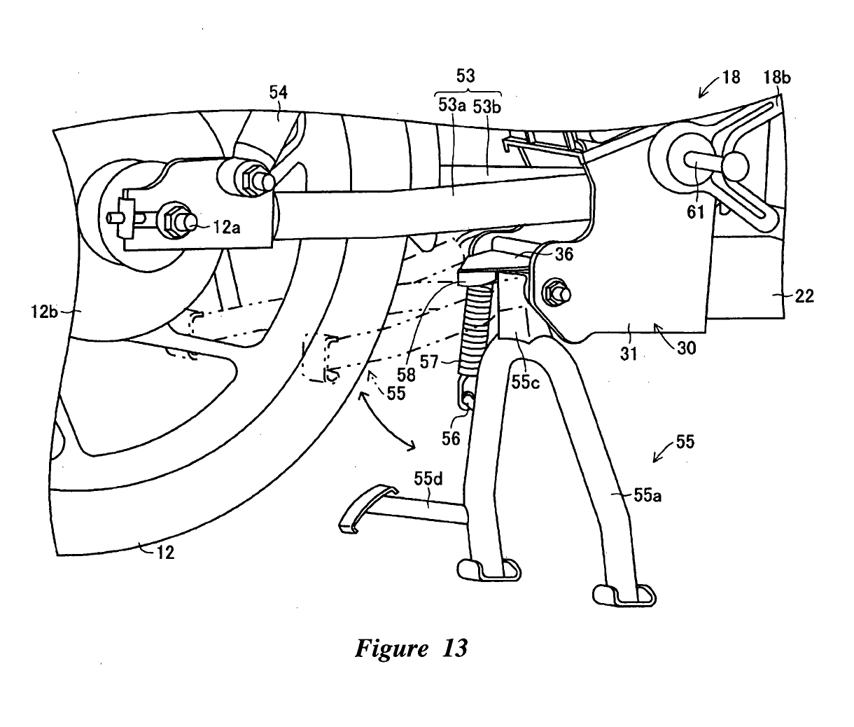

FIG. 13 is a perspective side view of a lower portion of the electric bicycle 10 shown in FIG. 11 with a kick stand 55 in solid lines when in a down position and in phantom lines when in an up position. The stand 55 attaches to the crank supporting unit 30 via opening 38a. The stand 55 pivots between a downward extending position and a generally horizontal extending position.

The stand 55 includes a stand body 55a having a pair of legs in a U-shape. As shown most clearly in FIG. 12, a support shaft 55b for the stand 55 is attached to the crankshaft supporting unit 30. A coupling section 55c connects a center or bending portion of the stand body 55a and a center portion of the support shaft 55b. A step section 55d extends from an outer surface of one of the pair of legs.

The support shaft 55b extends between the openings 38a of the side sections 31, 32 so that the stand 55 may pivot. The rider steps on the step section 55d to move the stand 55 from the horizontally extending position to the downward extending position. A spring engage pin 56 may be positioned at an upper portion in the outer surface on the one leg of the stand body 55a

A resilient member 57 extends between the spring engage pin 56 and the spring hooking pin 37 on the crankshaft supporting unit 30. The resilient member 57 urges the stand 55 upward. The resilient member 57 performs the function of urging the stand 55 toward the position at which the stand 55 extends rearward.

The reinforcing cross bar 35 of the crankshaft supporting unit 30 prevents the stand body 55a from further pivoting forward beyond the down position. Once pivoted to the down position, the stand body 55a does not move due to the spring member 57 biasing the stand 55 in a forward and upward direction.

A stopper 58 may be attached to the opening 36a in the crankshaft supporting unit 30. Once in the up position, the stopper 58 prevents the stand body 55a from further pivoting upward beyond the up position. The stopper 38 and the mounting piece 36 perform the function of preventing the stand 55 from pivoting beyond the up position.

The electric bicycle 10 may have a single bar stand 55 or two bar stands that extend separately from the base or coupling section 55c. The support shaft 55b may be positioned on one lateral side of the crankshaft supporting unit 30 or within the crankshaft supporting unit 30. If the support shaft 55b is disposed inside the crankshaft supporting unit 30, the coupling of the crankshaft supporting unit 30 to the support shaft 55b can rigidly anchor the stand 55 and still support the battery 46.

The side sections 31, 32 may pivotally hold the support shaft 55b therebetween. The stand 55 is pivotable about the axis of the support shaft 55b between the position at which the stand 55 keeps the body 10a in a standing condition and the position at which the stand 55 extends rearward. A distal end portion of the stand 55 is swingable. The crankshaft supporting unit 30 is rigidly anchored to support the battery 46 since the crankshaft supporting unit 30 pivotally holds the support shaft 55b of the stand 55.

The support shaft 55b is positioned below portions of the side sections 31, 32 where the coupling shaft 55b of the rear arm 53 extends therebetween. The support shaft 55b extends above or below the coupling shaft 55b of the rear arm 53. Thereby, the rear arm 53 and the stand 55 are compactly attached to the electric bicycle 10 and do not interfere with each other.

The pedal crank section 18 includes the pedal crankshaft 61 and the crankshaft supporting unit 30 for supporting the pedal crankshaft 61. The pedal crank section 18 further includes a sprocket 62 fixed to the pedal crankshaft 61. A cover 18a covers the pedal crank section 18. The cover 18a may be attached to the side section 31 of the crankshaft supporting unit 30 via a bracket 18b welded to the side section 31.

The chain 63 is wound around the sprocket 62 and a sprocket of the rear wheel 12. The chain 63 is coupled to an end of the pedal crankshaft 61 that extends outward from a lateral side of the crankshaft supporting unit 30. Thus, when the rider rotates the pedals 64, the drive force of the rider (i.e., manpower) is transmitted from the pedal crank section 18 to the rear wheel 12 through the chain 63. As shown in FIG. 12, the sprocket 62 is attached so as to be positioned directly under the rear frame member 42a. The rear frame member 42a thus protects the sprocket 62 and the chain 63.

To operate the electric bicycle 10, the rider sits on the seat 17 and turns the power switch on. The rider may rest his/her feet on the pedals 64. The rider controls the speed of the electric bicycle 10 by rotating the grip 24a clockwise and counter-clockwise. The electric motor 65 generates a driving force to the rear wheel 12 to propel the electric bicycle 10.

The rider may or may not add an additional driving force to the driving force generated by the electric motor 65. For example, the rider may rest his/her feet on the pedals 64 and not rotate the pedals 64. In this state, a one-way clutch on the rear wheel 12 isolates the chain 63 and pedals 64 from the driving force being provided by the electric motor 65. In this way, the pedals 64 are not rotated by the electric motor 65. In another state, the rider may rotate the pedals 64 with his/her feet to add an additional driving force to the driving force being generated by the electric motor 65. In this state, the one-way clutch on the rear wheel 12 allows the chain 63 to engage with the rear wheel 12 to transmit the rider derived driving force to the rear wheel 12.

The electric bicycle 10 may also be operated as bicycle without the electric motor 65. For example, a rider may operate the electric bicycle 10 as a bicycle when running on a level or downhill road. In this state, the rider rotates the pedals 64 to generate the driving force in the rear wheel 12.

The brake levers 25a, 25b operate the front and rear brakes to lower the running speed of the electric bicycle 10. The rate at which the speed of the electric bicycle 10 drops is based on the degree which the brake levers 25a, 25b are pulled towards the grips 24a, 24b. For example, the initial movement of the brake levers 25a, 25b may stop the electric motor 65. Further movement of the brake levers 25a, 25b towards the grips 24a, 24b activates the front and rear brakes. When the electric bicycle 10 is stopped, the rider turns off the power switch and rotates the stand 55 down to the ground so that the electric bicycle 10 stays upright on its own. The rider pulls the electric bicycle 10 rearward while stepping on the step section 55d so as to pivot the stand body 55a downward.

To recharge the battery 46, the rider connects the charging connection cord to the connector 52. To access the connector 52, the rider unlocks the lock mechanism using the key and rotates the unlocked seat 17 to the open position. The connector of the connection cord is connected to the connector 52. During charging, the seat 17 may be lowered to cover the upper surface of the rear cover member 16. With the seat 17 closed, the connection cord extends through a gap between the rear cover member 16 and the seat 17.

The support pieces 31c, 32c of the crankshaft supporting unit 30 together support the bottom receiving unit 47b which holds the lower end portion of the battery 46. The battery 46 thus can be positioned adjacent to the pedal crankshaft 61. Thereby, the battery 46 can be placed at a low position in the center of the body 10a in the fore to aft direction. This arrangement advantageously lowers the center of gravity of the electric bicycle 10. In addition, because the bottom receiving section 47b is directly disposed in the upper portion of the crankshaft supporting unit 30, the number of parts is reduced and their arrangement is compact.

Both of the rear end portions of the down tube 22 and the front end portion of the rear arm 53 are coupled with the crankshaft supporting unit 30. The crankshaft supporting unit 30 thus can be rigidly fixed to hold the battery 46. Both of the side sections 31, 32 support the pedal crankshaft 61 while the respective ends of the pedal crankshaft 61 extending through the side sections 31, 32. In addition, the cylindrical holder 34, the reinforcing cross bar 35, the mounting piece 36, the coupling shaft 53c of the rear arm 53, and the support shaft 55b of the stand 55 extend between the side sections 31, 32. Even though the crankshaft supporting unit 30 is relatively light in weight, the supporting unit 30 can rigidly support the battery 46.

The rear frame members 42a, 42b extend rearward and cover the front and top outer circumferential surfaces of the sprocket 62 while being spaced apart from one another. The rear frame members 42a, 42b thus can protect the sprocket 62. The rear frame members 42a and 42b protect the battery 46 since the rear frame members 42a, 42b are positioned on both sides of the battery 46. In addition, the coupling shaft 53c of the rear arm 53 and the support shaft 55b of the stand 55 extend between the side sections 31 and 32 of the crankshaft supporting unit 30 so that at least one is positioned above the other. Therefore, the rear arm 53 and the stand 55 can be compactly attached for swing movement without interfering with each other.

The electric bicycle 10 is not limited to the embodiment discussed above and can be properly modified. For example, although the electric motor 65 is placed at the rear wheel 12, the electric motor 65 can be placed at the front wheel 11 or other portions. However, in order to dispose the battery 46 closer to the pedal crankshaft 61 to achieve a compact arrangement, the electric motor 65 is preferably spaced apart from the pedal crank section 18.

In the embodiment discussed above, the down tube 22 is a single member. However, the down tube 22 can be formed with two members. The stand 55 is not limited to a pair of legs and can have one leg. In such an embodiment, the support shaft can be attached to the side surface of the crankshaft supporting unit 30. Also, the configuration of the crankshaft supporting unit 30 is not limited to the embodiment discussed above, and can be any structure that can be coupled with the down tube 22 and the rear arm 53 while supporting the battery 46.

The rear end portion of the down tube 22 is coupled with the front section of the crankshaft supporting unit 30 such that the longitudinal axis of the down tube 22 crosses the front section. This structure rigidly couples the down tube 22 with the crankshaft supporting unit 30. Preferably, the longitudinal axis of the down tube 22 crosses the front section of the crankshaft supporting unit 30 at right angles.

Although this invention has been disclosed in the context of a certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combine with or substituted for one another in order to form varying modes of the disclosed invention. Thus, it is intended that the scope of the present invention herein disclosed should not be limited by the particular disclosed embodiments described above, but should be determined only by a fair reading of the claims.

What is claimed is:

1. An electric bicycle comprising:
a pedal crankshaft;
a crankshaft support unit configured to support the pedal crankshaft;
an electric motor;
a battery configured to provide electric power to the electric motor; and
a support disposed above the crankshaft support unit and configured to support a bottom portion of the battery.

2. The electric bicycle according to claim 1, wherein the electric motor is disposed remotely from the pedal crankshaft.

3. The electric bicycle according to claim 1 further comprising a down tube, a head pipe, and a steering shaft, the down tube having a front end portion coupled to the head pipe and holding the steering shaft, and a rear end portion of the down tube being coupled to the crankshaft supporting unit.

4. The electric bicycle according to claim 3 further comprising a sprocket driving a wheel through a chain, the chain being coupled to the pedal crankshaft.

5. The electric bicycle according to claim 4 further comprising a pair of rear frame members coupled with the rear end portion of the down tube, wherein at least one of the pair of rear frame members extends rearward so as to cover front and top surfaces of the sprocket.

6. The electric bicycle according to claim 5, wherein the down tube comprises a single member, and further comprising a cross member extending generally horizontally to the down tube and being fixed to the rear end portion of the down tube, and wherein the pair of rear frame members are coupled to the cross member.

7. The electric bicycle according to claim 1 further comprising a rear arm having a front end portion, wherein the front end portion supports a wheel and is fixed to the crankshaft supporting unit.

8. The electric bicycle according to claim 1 further comprising a stand having a support shaft, wherein the support shaft is coupled to the crankshaft supporting unit.

9. The electric bicycle according to claim 8, wherein the stand is pivotable about an axis of the support shaft between a down position where the stand contacts a riding surface and an up position where the stand does not contact the riding surface.

10. The electric bicycle according to claim 8, wherein the crankshaft supporting unit has a U shape.

11. The electric bicycle according to claim 10, wherein the crankshaft supporting unit comprises a pair of side sections and a front section connected to the side sections, and wherein the side sections support end portions of the pedal crankshaft, and wherein the end portions extend through the side sections.

12. The electric bicycle according to claim 11, wherein the pair of the side sections pivotally hold the support shaft of the stand.

13. The electric bicycle according to claim 12, wherein the support shaft is disposed between the side sections of the crankshaft supporting unit.

14. The electric bicycle according to claim 9, further comprising means for urging the stand toward a position at which the stand extends rearward and means for limiting pivoting movement of the stand.

15. An electric bicycle comprising
an electric motor;
a crankshaft support unit having a pair of side sections, a front section connected to the pair of side sections, each side section having an upper surface, the upper surface supporting a battery support section;
a battery positioned on the battery support section; and
a pedal crankshaft extending between the pair of side sections of the crankshaft support unit.

16. The electric bicycle according to claim 15, wherein the pair of side sections and the front section together have generally a U shape.

17. The electric bicycle according to claim 15, wherein end portions of the pedal crankshaft extend beyond the side sections.

18. The electric bicycle according to claim 15, wherein the upper surface of each side section is spaced a distance from the pedal crankshaft so that an electric motor can not fit therebetween.

19. The electric bicycle according to claim 15 further comprising a stand having a support shaft, wherein the support shaft is coupled to the crankshaft supporting unit.

20. An electric bicycle comprising:
a pedal crankshaft;
an electric motor disposed remotely from the pedal crankshaft;
a crankshaft unit configured to support the pedal crankshaft, the crankshaft unit defining at least in part a support surface facing in a generally upward direction;
a mounting bracket disposed on the support surface; and
a battery for driving the electric motor coupled to the mounting bracket.
